(19) United States
(12) Patent Application Publication
(10) Pub. No.: US 2002/0107676 A1
(43) Pub. Date: Aug. 8, 2002

(54) Computer system for the analysis and design of extrusion devices

(76) Inventor: David L. Davidson, Pace, FL (US)

Correspondence Address: Craig M. Lundell, 750 Bering Drive, Houston, TX, 77057-2198, US

(21) Appl. No.: 10/040,275

(22) Filed: Nov. 1, 2001

Related U.S. Application Data
(60) Provisional application No. 60/244,854, filed on Nov. 1, 2000.

(51) Int. Cl. G06G 7/48

(52) U.S. Cl. 703/9

(57) ABSTRACT

A method for analyzing or designing a fluid extrusion device using a computer system involves inputting fluid rheological data and extrusion device data into a computer system having CFD numerical algorithms and a user interface; computing flow characteristics of the extrusion device; and extracting data relating to the flow characteristics.

This application claims the benefit of provisional application serial No. 60/244,854 filed Nov. 1, 2000.

### FIELD OF THE INVENTION

The present invention relates generally to a method for analyzing or designing extrusion devices utilizing mathematical modeling. Moreover, the present invention relates to a system for analyzing or designing extrusion devices.

### BACKGROUND

The modeling of solid objects is employed in various fields. Such modeling is used, for example, in the simulation of injection molding. In that field, it is widely recognized that the filling and packing phases of injection molding have a significant effect on the visual and mechanical properties of a molded object. Simulation is employed to analyze proposed shapes and injection points, and thus the final quality of the ultimate article. A requirement of any injection mold is that it can be filled with molten polymer given the pressure limits of a real injection molding machine. Simulation can provide information as to whether the mold can be filled and the fill pattern that will be achieved. By using simulation, it is possible to determine optimum gate locations and processing conditions. It is possible to predict the location of weld lines and air traps. Economic benefit is derived from simulation because problems can be predicted and solutions tested prior to the actual creation of the mold. This eliminates costly re-working and decreases the time required to get an object into production.

Simulation technology has been developed and generally uses finite element/finite difference/finite volume or other techniques to solve the governing equations of fluid flow and heat transfer. In order to minimize the time required for analysis and hence the required computer resources, the Hele-Shaw approximation is invoked to simplify the governing equations. It has been found that this simplification provides sufficient accuracy for injection molding but does create the need for specific modeling of the computational domain.

Injection molding is an excellent process for repetitively manufacturing large numbers of objects or parts having complicated geometrics. A characteristic of injection molded components is that the thickness of the wall is generally a small fraction of the overall length of the component. In view of the low thermal conductivity of plastics, this physical characteristic is essential to achieve the rapid cycle times that make the process so attractive.

The flow of melt in an injection mold is determined by the familiar conservation laws of fluid mechanics and the rheological behavior of the injected fluids. Solution of the equations in their full generality presents several practical problems. Owing to the characteristically thin walls of molded components, however, it is possible to make some reasonable assumptions that lead to a simplification of the governing equations. These simplified equations describe what is called Hele-Shaw flow and may be readily solved in complex geometries using an appropriate numerical technique such as the finite element and/or finite difference method.

Injection molding simulation is now routinely regarded as a desirable aspect of plastic part design. Similarly, improved computer aided drafting (CAD) technology has led to the widespread use of surface and solid modeling. Associated advantages of this are the ability to better visualize an object, to use numerical cutting, and the possibility of achieving more concurrency in engineering design and manufacture. When using the Hele-Shaw approximation, plastic CAE analysis still requires the use of a surface model, representing the midplane of the real component, which is then meshed with triangular or quadrilateral elements to which suitable thicknesses are ascribed. The preparation of such a mesh can take a considerable amount of time, and requires substantial user input; owing to the labor intensive nature of this step, model preparation requires the greatest share of time when performing a molding simulation and makes this technique time consuming. In addition, as model preparation is an interactive task, it has a higher cost associated with it than simply running a computer program.

One solution to the above shortcomings is to avoid the use of the Hele-Shaw equations and solve the governing equations in their full generality. This has inherent problems owing to the thin walled nature of injection molded objects and parts. To perform such an analysis, the region representing the mold cavity into which molten polymer will be injected must be divided into small sub-domains called elements. Usually these elements are of tetrahedral or hexahedral shape. This process of subdivision is called meshing and the resultant network of tetrahedra or hexahedra is called the mesh. Owing to the complicated shape of many injection molded objects and parts it is generally not possible to automatically mesh the cavity with hexahedral elements. It is possible, however, to mesh the domain automatically with tetrahedral elements. The thin walled nature of injection molded objects and parts means that the plastic is subject to a huge thermal gradient in the thickness direction of the component. This requires that there be a reasonable number of elements through the thickness. Using existing meshing technology, the result is a mesh consisting of hundreds of thousands or even millions of elements. The high number of elements makes the problem intractable for any but the fastest super computers. These are rarely found in industry, being extremely costly to purchase and maintain. Thus, although three dimensional simulation provides a solution that avoids the requirement of a midplane model, it is not as yet a practical solution.

For example, U.S. Pat. Nos. 6,096,088 and 4,989,166, the entire subject matter of which is incorporated herein by reference, describe processes for modeling fluid flow in molds to design plastic articles prepared therefrom. Modeling of the quench zone in melt spinning polyethylene terephthalate (PET) has also been performed using numerical analysis, Dr. V. M. Nadkarni and Dr. V.S. Patuardhan, Simulation Software For Multifilament Melt Spinning Of PET, International Fiber Journal, December 1999, pp. 64-69. However, this system only models the extrudate or fiber exiting the extrusion device or spinneret pack. Due to the inherent limitations of this system, it would not be suitable for use in the design of the extrusion device itself, only the quench zone (i.e., the portion of the process in which the fiber exits the spinneret pack up to drawing and annealing of the fiber).

Accordingly, there is a need for a modeling system and process that will accurately simulate an entire plastic extrusion process, which would enable the accurate analysis and/or design of extrusion devices without requiring super computers. Moreover, there is a need for such a system that is easy to use and that is not prohibitively labor intensive.

### SUMMARY OF THE INVENTION

The present invention relates to a method for analyzing or designing a fluid extrusion device using a computer system by inputting fluid rheological data and extrusion device data into the computer system, the computer system having Computational Fluid Dynamics (CFD) numerical algorithms and a user interface, computing flow characteristics of the extrusion device, and extracting data relating to the flow characteristics.

The present invention also relates to a computer system for analyzing or designing a fluid extrusion device having CFD numerical algorithms and a user interface.

### BRIEF DESCRIPTION OF THE DRAWINGS

These and other objects, advantages, and features of the present invention will be apparent to those skilled in the art upon reading the following description with reference to the accompanying drawings in which:

FIG. 1 is a schematic representing elements of the modeling system according to the present invention;

FIG. 2 is a flowchart of the method for modeling the flow through a spinneret pack according to the present invention;

FIG. 3 is a schematic representation of a typical spin pack used for bicomponent fiber spinning, and a listing of important physics that occur in the pack and important quantities and phenomena of interest to fiber spinners.

FIG. 4 is an exploded view of a spin pack of a particular design (a pack with a melt pool) that illustrates the algorithm used to model the flow in such a pack according to the present invention.

FIG. 5 is a flowchart of the method for modeling the flow through a spinneret pack and the subsequent fiber quench device according to the present invention.

FIG. 6 is a schematic representation of the filament extrusion and quenching zone, its positional relationship to the pack, and typical modeling results for this zone according to the present invention.

FIG. 7 is a representation of quench air flow pattern in the quenching zone.

FIG. 8 is a representation of filament crystallinity within the quenching zone chimneys.

FIG. 9 is a representation of filament temperature within the quenching zone chimneys.

FIG. 10 is a graph representing improvement in filament to filament flow distribution obtained utilizing the present invention.

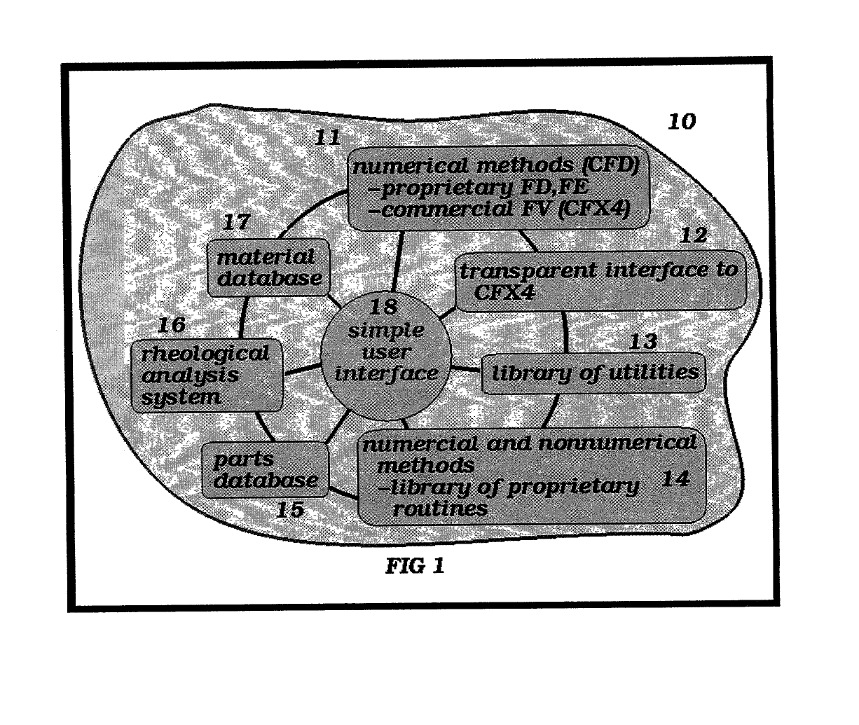

FIG. 1 1 is a flowchart of a conventional fiber development process compared to a design process of the present invention.

### DETAILED DESCRIPTION OF PREFERRED EMBODIMENTS

One embodiment of the present invention relates to a system for modeling the flow of a material through an extrusion device. This simulation allows for the analysis or troubleshooting of existing extrusion devices and/or the design of new extrusion devices without physically modifying or constructing such devices first. This embodiment of the present invention is illustrated by FIG. 1, which depicts a modeling system including computational fluid dynamics (CFD) numerical methods 11, an interface to a commercial CFD code 12, a library of utilities 13, non-CFD numerical and non-numerical methods 14, a parts database 15, a rheological analysis system 16, a materials database 17 and an interface 18 between components 11-17 and a user. The CFD numerical methods include finite element, finite difference and finite volume methods, and provide solutions to the mass, energy and momentum transport equations within the device and extrusion zone. The commercial CFD code interface 12 contains a collection of algorithms and functions that integrate the present invention into the commercial CFD code in such a way that the user need not know how to use the commercial code, or even recognize that it is being used. Such commercial code is, for example, CFX4 and is available from AEA Technology plc. The collection of algorithms can include coordinate transformation algorithms, root solving algorithms, sorting algorithms, mesh generation algorithms, various statistical algorithms, curve fitting algorithms, functional minimization algorithms, various interpolation and extrapolation algorithms, and linear and nonlinear equation solving algorithms. The user interface can include functions that prompt the user for appropriate input, issue warnings, display results, and translate user input and algorithm output into readily usable formats.

The library of utilities 13 consists of a collection of functions that provide integration and user interface capabilities and a variety of other needed capabilities, for example, a Fortran subroutine that manages the opening and closing of data files. The non-CFD numerical and non-numerical methods 14 consists of a collection of numerical and non-numerical algorithms that are used by the system for various purposes. For example, this component contains multiple string manipulation algorithms, subroutine or functions that are used to provide a user-friendly interface. In addition, this component contains mathematical algorithms for performing analytic geometry calculations, root finding and coordinate transformations. The parts database 15 contains complete geometric and material descriptions of the pack components and extrusion zone components. The rheological analysis system 16 contains the algorithms required to analyze raw rheometric data for fluids, generate rheological models, generate tabular and graphical representations of the analysis and data, and enter the information into the materials database 17. The materials database 17 contains rheological, heat transfer and other properties of the polymers and other materials that are simulated by the system. “Polymer” as used herein may be a polymer, copolymer, terpolymer, oligomer, etc., and may include synthetic and non-synthetic materials. This includes polymers such as nylon-6, nylon 6,6, polyethylene, polypropylene and polyester. The fluid may include additives, fillers, conductive materials, optical modifiers, etc.

The modeling method and system of the present invention may be utilized in analyzing and designing a variety of extrusion devices, including spinneret packs for producing fibers, and extrusion devices for producing films, molded products, pellets, or strands.

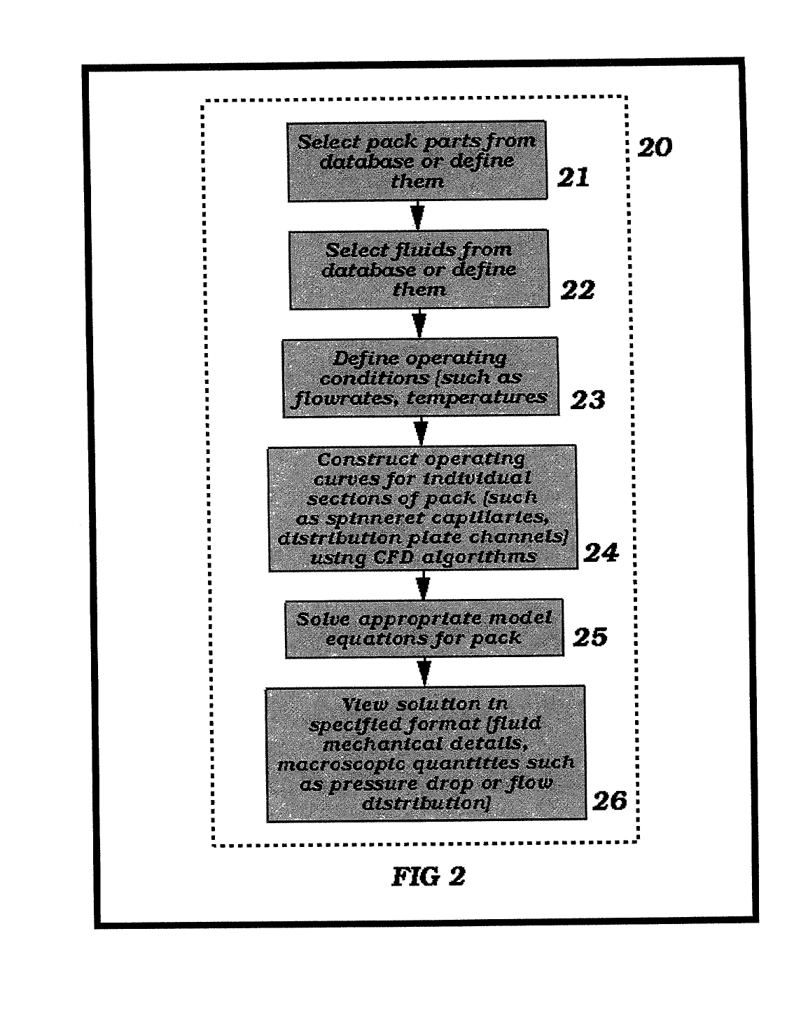

Another embodiment of the present invention regards a method for analyzing and/or designing an extrusion device utilizing a modeling system of the present invention. An example of this embodiment of the present invention includes the modeling of flow in a spinneret pack 20 and is illustrated by FIG. 2, which includes selecting pack parts from the parts database and/or defining them 21, selecting fluids from the materials database and/or defining them 22, defining appropriate operating conditions 23, construction of the operating curves for individual sections of the pack 24, solving the appropriate model equations for the pack 25, and viewing the appropriate results of the modeling 26. The modeled data can include flowrates through various channels within the pack, pressure drop across various channels within the pack, exit temperatures of various channels within the pack, polymer interface locations at various channel exits within the pack, shear rates and shear stresses at channel walls within the pack, and measures of hydrodynamic instability at various positions within the pack. Construction of the operating curves is accomplished automatically by the computer system. Such a system is intelligent enough to know what channels it must compute operating curves for, for which fluids and over what operating ranges. Furthermore, the system chooses the appropriate CFD methods, executes the CFD calculations, monitors convergence and completion, tabulates results and notifies the user when all calculations are complete. Because of this system intelligence, the user need not have any knowledge of CFD whatsoever to effectively use the system. Solution of the appropriate model equations for the pack is also accomplished automatically, the appropriate methods being chosen by the system. The solution format can cover a wide range, including tables, line graphs and three dimensional animations of pack flow.

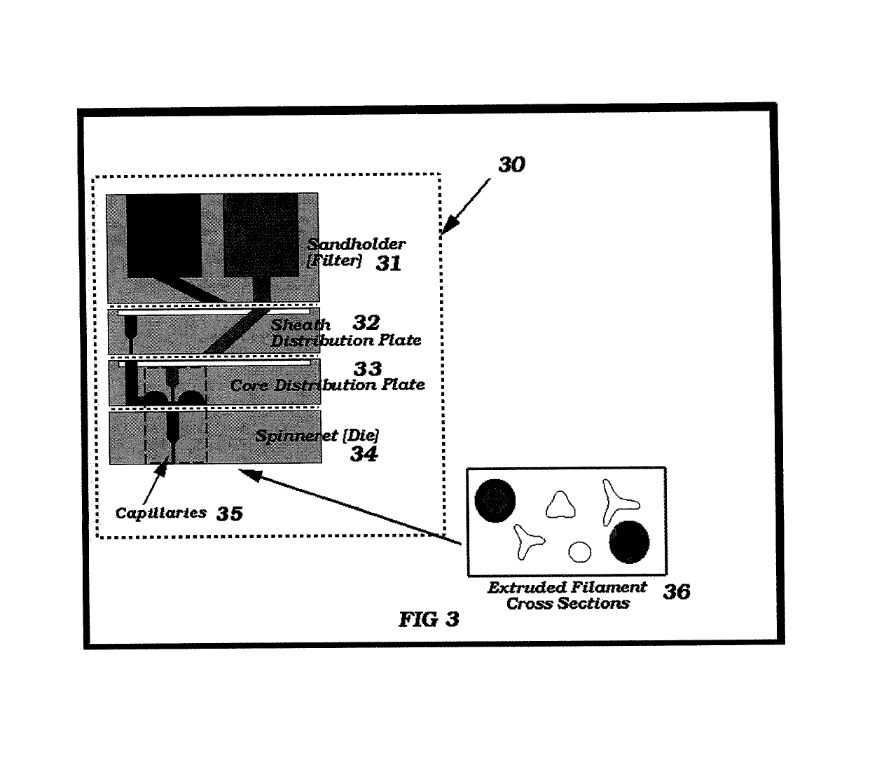

In one embodiment according to the present invention, the modeling system and method may be utilized to analyze or design a spinneret pack. A typical spinneret pack 30 shown in FIG. 3 is composed of filter 31, one or more distribution plates (32 and 33) and a spinneret die 34. Even though FIG. 3 illustrates a bicomponent fiber spinneret pack, it will be appreciated that the present invention may be utilized for the analysis and/or design of spinneret packs for single component fibers or any multi-component fibers. Additionally, any dimensions of the spinneret pack components and die configurations may be employed. The filter 31 may have many forms, such as the open cavity shown in the figure, and contain many and multiple different kinds of filter media, such as metal woven and etched screens, sand, glass, or particulate metal. The purpose of the filter 31 is at least to remove unwanted material from the entering fluid streams, although it may accomplish other purposes as well, such as altering the temperature profile within the fluids. The distribution plates 32 and 33 may have many forms as well, consisting of holes, channels and slots in various combinations, the purpose of which is to distribute the fluids to the spinneret capillaries 35 in the desired proportions. The spinneret is the extrusion die 34, and is used to form the fibers. The die holes may be any size and shape (i.e., round, multi-lobal, etc.), in principle, and their design can accomplish other objectives beyond controlling filament shape and size, such as controlling stability of the fibers within the quench zone. The spinneret pack may be designed to produce any fiber configuration 36, including coalescing filaments (i.e., filaments composed of multiple extradate streams, such as hollow filaments), and noncoalescing including, but not limited to sheath core, striped, multi-lobal, eccentric, etc.

In another embodiment of the present invention, a modeling method and system as described herein are enhanced by assuming that the flow of material through portions (e.g., channels) of the extrusion device is fully developed instantaneously. This flow may be demonstrated by the following expression:

t_{D}/t_{C}=(RE R)/(2L)<<1

wherein:

t_{D}=characteristic time scale for diffusive momentum transport in channel (□ to flow);

t_{D}=residence time in channel;

Re=channel Reynolds number;

R=characteristic dimension of the channel perpendicular to flow, such as radius;

L=length of channel.

In other words, the time required for diffusive momentum transport is much less (i.e., less than 1/10) than the residence time in the channel, or said another way, diffusive momentum transport is much faster than convective transport in the channels. This is frequently true for polymeric materials used in fiber spinning, but can be valid for any material in general.

This assumption provides a modeling system and method that is accurate (i.e., precise to within the limits of what is satisfactory for part design), versatile (i.e., applicable to any extrusion device and with any material), not labor intensive (i.e., avoids the need for the user to generate a separate CFD mesh for every part), and alleviates the requirement of “super” computers (e.g., expensive computers that have high computation speed, memory or parallel (or clusters) of computers) that would normally be needed to obtain acceptable modeling of extrusion devices. Accordingly, this system may be employed with typical or average central processing units.

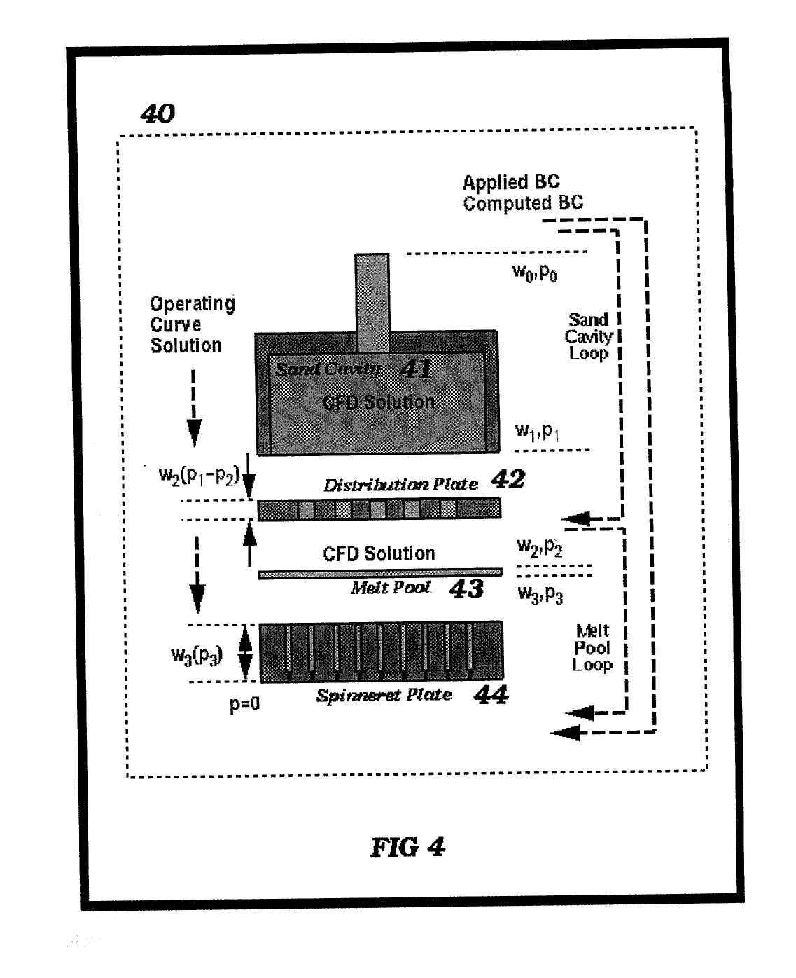

In accordance with the present invention, FIG. 4 represents a process 40 for analysis and/or design of a spin pack. In this case, the computer system breaks the pack into its component parts (sand cavity 41, distribution plate 42, melt pool 43 and spinneret plate 44 in this example), and applied CFD methods to the solution of the flow in each part of the pack. The solutions to the individual CFD problems at the boundaries (boundary conditions, abbreviated BC in the figure) are matched and the process iterated in the manner shown in the figure until converged solutions are obtained for each pack component. For example, the spin pack problem is broken up into multiple components (as shown in FIG. 4, four components, e.g., sand cavity 4, distribution plate 42, melt pool 43, and spinneret plate 44). The combination of the assumption set forth in Equation I and the process of breaking up the problem into easily soluble components, allows for rapid and repetitive solution to the problem with inexpensive computers and no user CFD expertise.

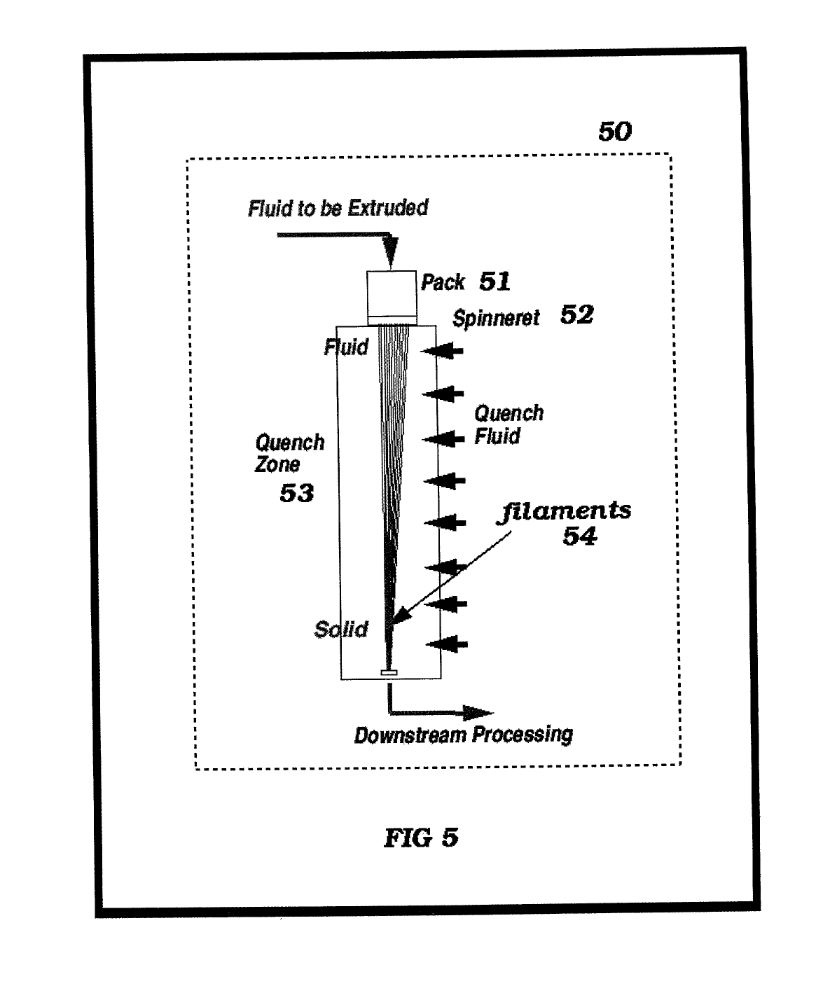

In another embodiment of the present invention, an entire extrusion process may be modeled using a system and process of the present invention. For example, not only may the extrusion device be modeled, but also subsequent processing of the extrudate may also be modeled. FIG. 5 represents a fiber-forming process 50 (e.g., a polymeric material) including spinning of the fiber and subsequent quenching of the fiber. Fluid is introduced into the pack 51, as discussed above, extruded through the spinneret plate 52 and introduced into the quench zone 53. In the quench zone 53, the filaments 54 are formed, solidified and cooled, and often oriented and crystallized as well. In addition to what is shown in this figure, in typical industrial spinning machines multiple quench zones are operated side by side, the collection of all such zones constituting the spinning machine. All of the zones discharge quench fluid into the region next to the machine. The interaction between the fluid flow in the quench zones and the region next to the spinning machine is important, and should be accounted for in the modeling of fiber formation.

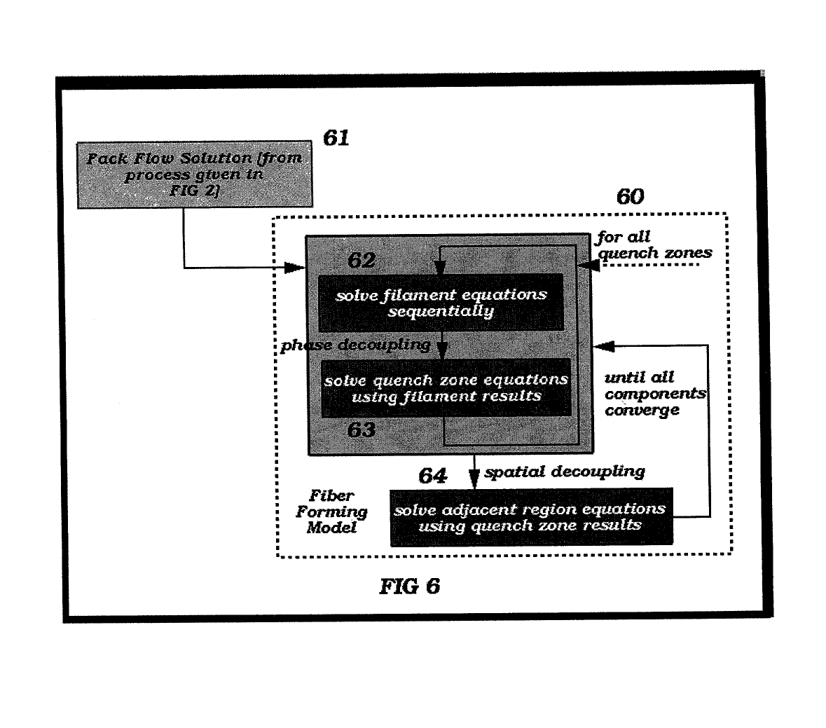

To this end, FIG. 6 illustrates the process 60 by which the computer system performs fiber forming analysis. The results from the pack analysis calculations 61 are used as input into the fiber forming analysis model 60. This model 60 consists of three primary CFD calculations, one for the filaments 62, one for the quench zone 63 and one for the region 64 next to or adjacent to the quench zone. These are solved separately, but the boundary conditions are matched by an iterative process, whereby upon completion the solution is obtained for all filaments, all quench zones and the region adjacent to the chimney. Modeling of multiple spinning machines can be accomplished as well, by appropriate use of symmetry boundary conditions in the adjacent region calculation.

The modeling of a complete spinning machine using the methods of computational fluid dynamics is an intractable problem, due to the wide disparity in relevant length scales (very small fibers, very large spinning machines) and important physical phenomena, and to the fact that the interaction of the quench zone with the adjacent region is important. It is this approach of breaking the problem up into three separate CFD problems (filaments, quench zones, adjacent region) and iteratively matching these solutions together that makes the problem tractable with modest computer resources and no knowledge of CFD on the part of the user.

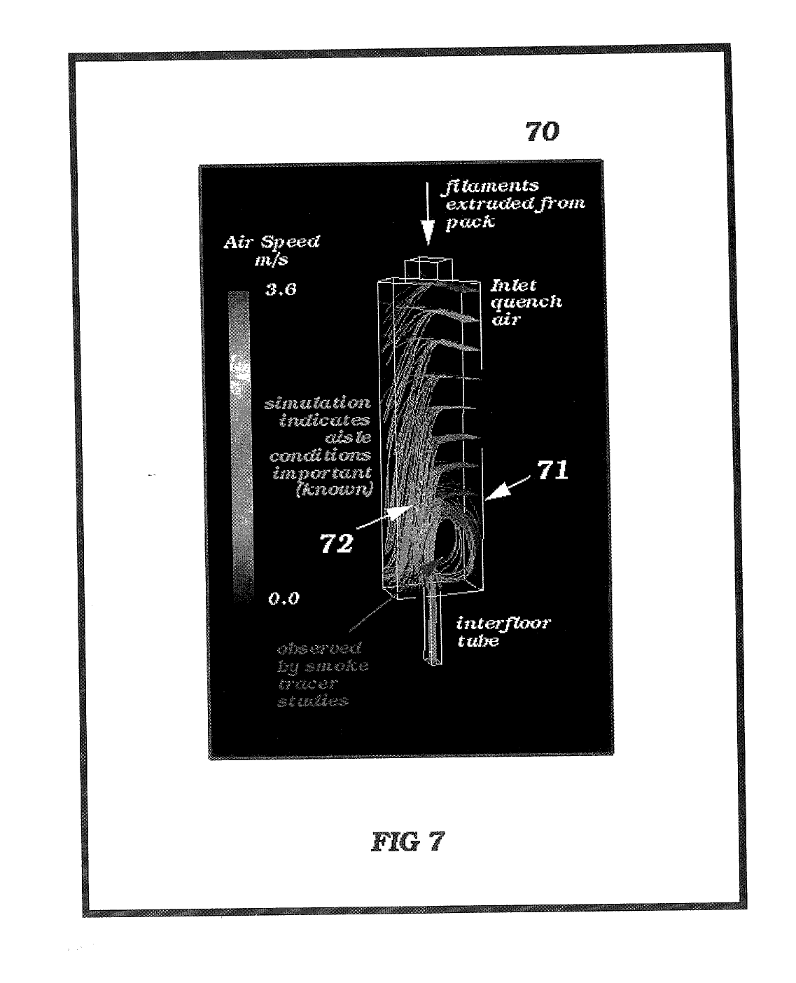

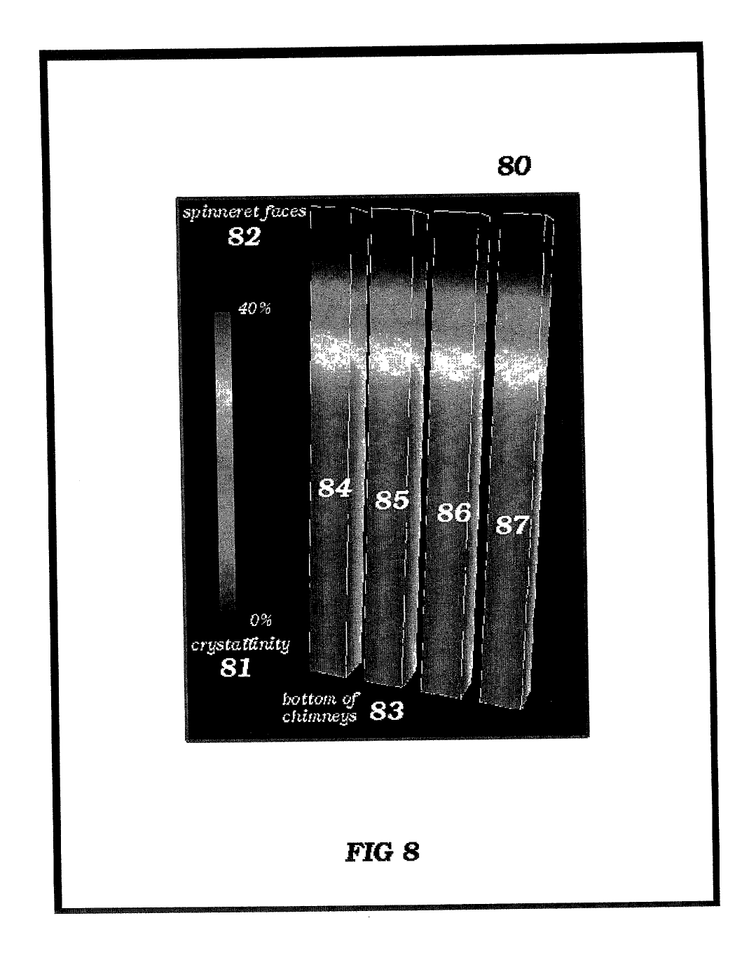

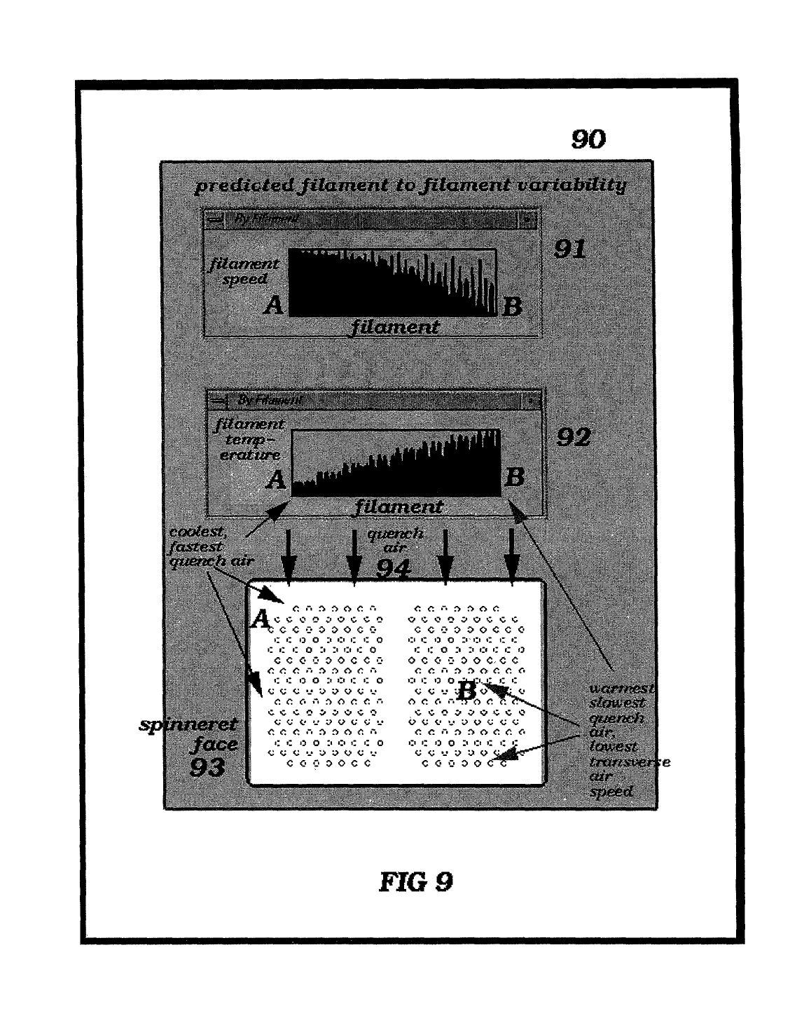

FIGS. 7-9 illustrate the kind of information that can be obtained from a filament formation model. FIG. 7 shows a simulation 70 in a fiber forming process. The downward drag of the filaments on the quench air is evident from the quench air streamlines 72. This includes but is not limited to fluid streamlines 72 (that is, quench air flow pattern) within the quench chimney, and filament properties such as temperature and crystallinity (for semicrystalline and crystalline materials) for every filament within every chimney. FIG. 8 represents crystallinity 81 from the spinneret face 82 to the bottom of the chimneys 83 throughout bunches of filaments 84-87 in four consecutive chimneys of a fiber spinning machine. The filament information can be plotted as a distribution, which is helpful for optimizing existing designs and generating new designs. FIG. 9 illustrates filament to filament variability with regard to certain properties (e.g., filament speed 91 and filament temperature 92) at the bottom of a chimney. The filaments exiting the spinneret face 93 are exposed to quench air 94 penetrating the filament's bundle. As is readily apparent, region A is quenched much more effectively than region B, which is illustrated by the higher filament speed (91A) and lower filaments temperature (92A).

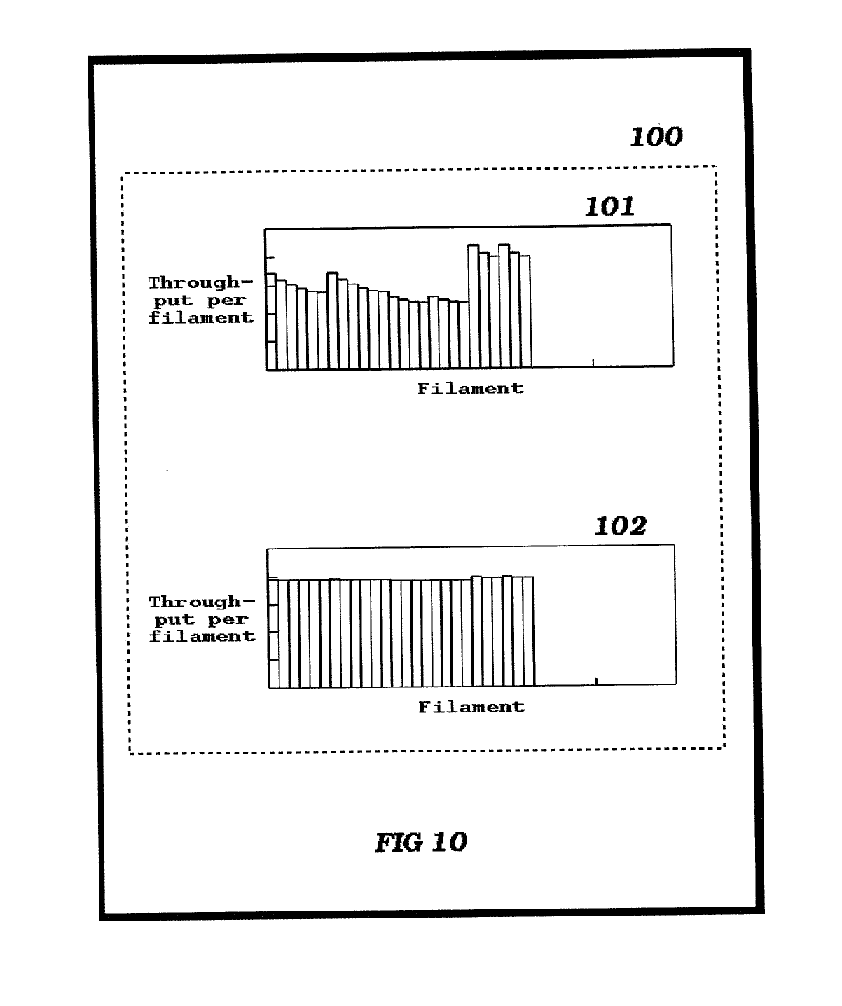

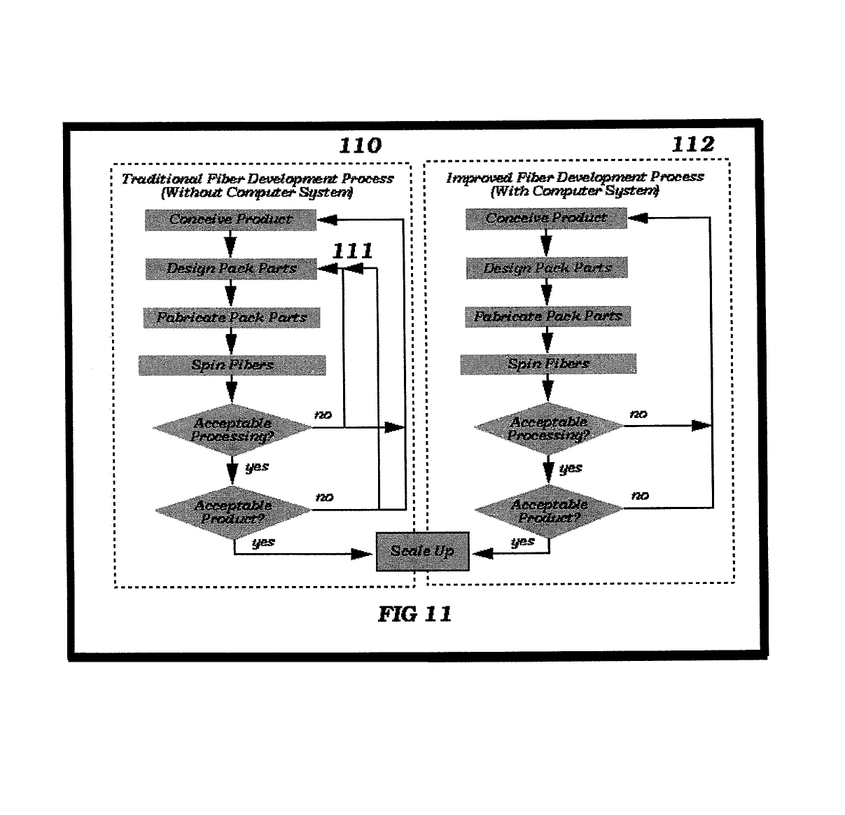

FIG. 10 shows a typical improvement in filament to filament distribution 100 that is obtained using the computer system of the present invention. The system first predicts the upper distribution 101, which is poor because there is an unacceptable difference in throughput from one filament to the next, then allows the user to easily redesign the pack components (e.g., the distribution plate and/or the spinneret plate) in order to obtain the lower distribution 102, which is excellent, in that very little variation in throughput from filament to filament exists.

FIG. 1 1 shows the impact that the use of the system on the fiber development process. According to traditional fiber development processes 110 of the present invention imparts, proper design of pack parts is an iterative process 111, requiring significant expenditure in experimental, pilot plant and/or plant trials. In the fiber development processes with this computer system 112, the pack part design iteration is eliminated—pack parts can be designed right the first time.

As is readily apparent from the description of the present invention, the benefits of this computer system include 1) simple user interface that permits wide use of the system, 2) high quality numerical methods and fluid mechanical models that provide accurate answers, 3) highly integrated system that allows the user to perform a wide variety of realistic analyses and designs with little effort, 4) parts and material databases that allow users to select pack and quench hardware components with little effort, 5) judicious use of sound physical assumptions that permit repeated use of the system without requiring the user to generate or even know anything about CFD, and without requiring enormous computational resources.

All of the devices and methods disclosed and claimed herein can be made and executed without undue experimentation in light of the present disclosure. While the devices and methods of this invention have been described in terms of preferred embodiments, it will be apparent to those of skill in the art that variations may be applied to the devices and methods and in the steps or in the sequence of steps of the method described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for analyzing or designing a fluid extrusion device using a computer system comprising,
inputting fluid rheological data and extrusion device data into said computer system, said computer system comprising CFD numerical algorithms and a user interface;
computing flow characteristics of said extrusion device; and
extracting data relating to said flow characteristics.

2. A method according to claim 1, wherein said fluid comprises a polymer.

3. A method according to claim 2, wherein said polymer is selected from the group consisting of nylon-6, nylon-6,6, polyethylene, polypropylene, and polyester.

4. A method according to claim 2, wherein said polymer further comprises additives, fillers or other solids.

5. A method according to claim 1, wherein said extrusion device comprises a fiber spinneret pack.

6. A method according to claim 1, wherein said rheological data comprises a relationship between shear and/or extensional viscosity with shear and/or extension rate and temperature.

7. A method according to claim 1, wherein said extrusion device data comprises a filtration zone, at least one distribution plate and a die.

8. A method according to claim 7 wherein the filtration zone comprises a sand cavity.

9. A method according to claim 1, wherein said numerical algorithms comprise algorithms selected from the group consisting of coordinate transformation algorithms, root solving algorithms, sorting algorithms, mesh generation algorithms, statistical algorithms, curve fitting algorithms, functional minimization algorithms, interpolation and extrapolation algorithms, and linear and nonlinear equation solving algorithms.

10. A method according to claim 1, wherein said computer system further comprises non-numerical algorithms.

11. A method according to claim 1, wherein said user interface comprises functions selected from the group consisting of functions that prompt the user for appropriate input, issue warnings, display results, and translate user input and algorithm output into readily usable formats.

12. A method according to claim 1, wherein said flow characteristics are selected from the group consisting of flow rates and fluid velocities at various positions within the pack, pressures at various positions within the pack, temperatures at various positions within the pack, the locations of polymer interfaces throughout the pack and shear and elongation rates at various positions within the pack.

13. A method according to claim 1, wherein said extracted data is selected from the group consisting of flowrates through various channels within the pack, pressure drop across various channels within the pack, exit temperatures of various channels within the pack, polymer interface locations at various channel exits within the pack, shear rates and shear stresses at channel walls within the pack and measures of hydrodynamic instability at various positions within the pack.

14. A method according to claim 1, wherein said extrusion device comprises channels within which fluid flow is characterized by a velocity profile that is fully developed instantaneously.

15. A method according to claim 14, wherein said fluid flow is characterized by the following expression:
t_{D}/t_{C}=(Re R)/(2L)<<1
wherein:
t_{D}=characteristic time scale for diffusive momentum transport in channel (□ to flow);
t_{c}=residence time in channel;
Re=the Reynolds number;
R=channel radius;
L=length of channel.

16. A computer system for analyzing or designing a fluid extrusion device comprising,
numerical algorithms; and
a user interface,
wherein said system can be used to perform the method of claim 1.
